(19) United States
(12) Patent Application Publication
(10) Pub. No.: US 2009/0264234 A1
(43) Pub. Date: Oct. 22, 2009

(54) Electric rotary machine

(75) Inventor: Tooru OOIWA, Toyota-shi (JP)

Correspondence Address: OLIFF & BERRIDGE, PLC, P.O. BOX 320850, ALEXANDRIA, VA, 22320-4850, US

(73) Assignee: DENSO CORPORATION, Kariya-City (JP)

(21) Appl. No.: 12/385,754

(22) Filed: Apr. 17, 2009

(30) Foreign Application Priority Data
Apr. 21, 2008 (JP) 2008-109708
Sep. 22, 2008 (JP) 2008-242344

(51) Int. Cl. F16H 55/06

(52) U.S. Cl. 474/161

(57) ABSTRACT

An AC generator for vehicles as an electric rotary machine, a pulley is fixed to a rotating shaft, and a belt transmits a driving force from outside to the rotating shaft via the pulley. The pulley comprises a cylindrical portion in contact with the belt, an attachment part screwed and fixed to the rotating shaft by fitting, a supporting part which joins the attachment part and the cylindrical portion, and a reinforcement part having its form projected to an inner diameter side of the cylindrical portion that is located in the opposite side of the supporting part to the direction against the center position of an axis of the belt

### CROSS-REFERENCE TO RELATED APPLICATION

This application is based on and claims the benefit of priority from earlier Japanese Patent Applications No. 2008-109708 filed on Apr. 21, 2008 and No. 2008-242344 filed on Sep. 22, 2008, the descriptions of which are incorporated herein by reference.

### BACKGROUND OF THE INVENTION

1. Technical Field of the Invention

This invention relates to an electric rotary machine, such as an AC generator for vehicles equipped in a passenger car, a truck, and the like.

2. Description of the Related Art

Referring to Japanese Patent Application Laid-open Publication No. 2007-28832, for example, an AC generator for vehicles provided with a pulley that includes a metal insertion member as a component is known. Replacing the iron-made pulley generally used before to the resin-made pulley can lighten the weight of the AC generator.

Since a pulley is something that rotates with a rotor, reducing the weight of the pulley leads to a reducing in the weight of the whole rotating body, and it is effective in preventing generation of belt slide or belt squeak due to the reduction of the moment of inertia of the rotating body, while the load of the engine that drives the rotating body is reduced.

In addition, since the insert is used for the part where axial stress is added when the pulley is tightened with a nut during assembly, slacking of the nut due to slow deformation of the pressed side over time can be prevented.

By the way, in the AC generator for vehicles disclosed in the above-mentioned Laid-open Publication, there was a problem that the reliability of the pulley fell as a result of long-term use, since strength of the cylindrical portion that forms a groove of the pulley is reduced due to the rotation drive power acting repeatedly on the groove perimeter from the belt.

The present invention has been made in order to solve the issue described above, and has as its object to provide an electric rotary machine that can raise strength of a cylindrical portion of a pulley and can raise the reliability of the pulley.

### SUMMARY OF THE INVENTION

In order to solve the subject mentioned above, an electric rotary machine comprises a pulley fixed to a rotating shaft, and a belt that transmits a driving force from outside to the rotating shaft via the pulley.

The pulley further comprises a cylindrical portion in contact with the belt, an attachment part screwed and fixed to the rotating shaft by fitting, a supporting part which joins the attachment part and the cylindrical portion, and a reinforcement part that has projections on an inner diameter side of the cylindrical portion, and is located in the opposite side of the supporting part opposite side to the direction against the center position of an axis of the belt.

Since the cylindrical portion serves as a supporting structure that supports one side of the belt center by the supporting part, and supports the other side of the belt center by the reinforcement part, strength of the cylindrical portion can be raised and it becomes possible to raise the reliability of the pulley.

In a preferred embodiment, the cylindrical portion has a groove in contact with the belt, and at least a portion of the groove that touches the belt is formed with resin.

In a preferred embodiment, the reinforcement part is a separate part from the cylindrical portion, but formed of the same type of the material with the cylindrical portion having the same coefficient of linear expansion, and is press fit and fixed to an inner surface of the cylindrical portion. Preferably, when the reinforcement part is press fit into the cylindrical portion, an interference of the press fit is set to 0.1 mm or less.

In a preferred embodiment, the reinforcement part has an opening opened to the inner diameter side thereof.

In a preferred embodiment, a diameter of the opening in the inner diameter of the reinforcement part is set larger than a jig for tightening and loosening a nut used for screwing the attachment part.

In a preferred embodiment, the reinforcement part has an opening opened to the inner diameter side thereof.

In a preferred embodiment, while the reinforcement part is a separate part from the cylindrical portion, but formed of the same type of the material with the cylindrical portion having the same coefficient of linear expansion, and is engaged to the cylindrical portion, the reinforcement part is engaged and fixed to either the attachment part or to the supporting part.

In a preferred embodiment, while the reinforcement part is a separate part from the cylindrical portion and engaged to the cylindrical portion, the reinforcement part is engaged and fixed to either the nut or to the rotating shaft.

In a preferred embodiment, while the reinforcement part engages with the cylindrical portion according to a screwing structure, the reinforcement part is engaged and fixed by press fitting to either the attachment part or to the supporting part in the direction of its axis.

In a preferred embodiment, while the reinforcement part engages with the cylindrical portion according to the screw structure, the reinforcement part is engaged and fixed by press fitting to either the nut or to the rotating shaft in the direction of its axis.

In a preferred embodiment, the reinforcement part is engaged and fixed to the cylindrical portion, the attachment part, and the supporting part by adhesion.

In a preferred embodiment, the reinforcement part is engaged and fixed to the cylindrical portion, the nut, and the rotating shaft by adhesion.

### BRIEF DESCRIPTION OF THE DRAWINGS

In the accompanying drawings:

FIG. 1 shows a sectional view of a whole composition of an AC generator for vehicles according to an embodiment of the present invention;

FIG. 2 shows a sectional view of a pulley;

FIG. 3 shows a sectional view of a first modification of the pulley;

FIG. 4A shows a partial front view of a second modification of the pulley;

FIG. 4B shows a sectional view taken along the line A-A of FIG. 4A;

FIG. 5 shows a sectional view of a third modification of the pulley; and

FIG. 6 shows a sectional view of a fourth modification of the pulley.

### DETAILED DESCRIPTION OF THE PREFERRED EMBODIMENTS

With reference to the accompanying drawings, hereinafter will be described an embodiment of the present invention, an electric rotary machine, which is applied to an AC generator for vehicles.

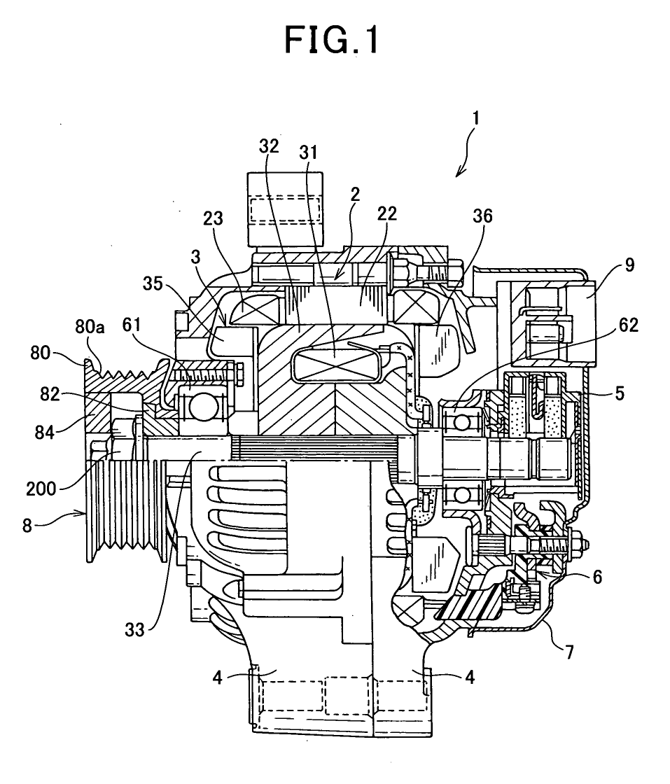

FIG. 1 is a sectional view showing a whole composition of the AC generator for vehicles according to an embodiment.

The AC generator 1 for vehicles (hereinafter, shortened to “the AC generator 1”) shown in FIG. 1 is constituted including a stator 2, the rotor 3, a frame 4, a brush device 5, a rectifying device 6, a rear cover 7, a pulley 8, and the like.

The stator 2 is arranged at a perimeter of the rotor 3, and is provided with a stator core 22 and the stator winding 23 coiled around a plurality of grooves formed in the stator core 22 at the predetermined intervals.

The rotor 3 has a structure of a field winding 31 made of an insulated copper wire that is coiled coaxially and cylindrically, which is sandwiched in between pole cores 32, each having a plurality of magnetic pole nail portions, through a rotating shaft 33.

In addition, cooling fans 35 and 36 are attached in the end surface of the pole core 32 by welding etc. The rotor 3 rotates with the rotating shaft 33 integrally.

The frame 4 accommodates and holds the stator 2 and the rotor 3 therein, and the rotor 3 is supported rotatably via bearings 61 and 62 with the rotating shaft 33 in the center, while the stator 2 arranged within the frame 4 in a predetermined crevice is fixed at the perimeter side of the pole core 32 of the rotor 3.

The brush device 5 is for passing exciting current from the rectifying device 6 to the field winding 31 of the rotor 3, and has brushes pressed to collector rings formed in the rotating shaft 33 of the rotor 3.

The rectifying device 6 is for obtaining the DC (direct current) output electric power by rectifying the AC (alternating current) output voltage of the stator winding 23.

A rear cover 7 covers and protects the brush device 5 attached in the outside the rear side of the frame 4, the rectifying device 6, and an IC regulator 9 entirely.

In the AC generator 1 for vehicles with the structure mentioned above, the rotor 3 will rotate in the predetermined direction when the torque from an engine (not shown) is transmitted to the pulley 8 via a belt.

By applying excitation voltage to the field winding 31 of the rotor 3 from the exterior in this state, each tip part of the pole core 32 is excited, thus the stator winding 23 can generate three phase AC voltage, and the DC output electric power is extracted from an output terminal of the rectifying device 6.

Next, the details of the pulley 8 are explained.

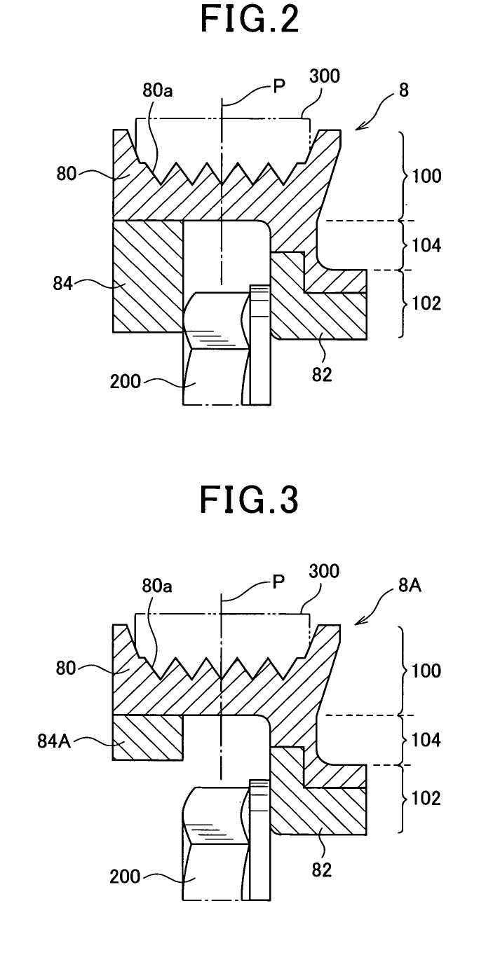

FIG. 2 is a sectional view of the pulley 8 with a nut 200 that fastens and fixes the pulley 8 to the rotating shaft 33, and is shown on only one side of a center axis.

As shown in FIGS. 1 and 2, the pulley 8 is constituted including a resin part 80 by which pulley grooves 80a are formed in its perimeter, an iron part 82 by which is inserted in the inner circumference side of the resin part 80, and a reinforcement part 84.

The cylindrical portion 100 that has grooves in contact with a belt 300 is formed by a part of the resin part 80. Thus, at least a portion of the groove that touches the belt 300 is formed with resin.

Further, an attachment part 102 is fitted and screw-fixed to the rotating shaft 33 is formed by a part of the resin part 80 and a part of the iron part 82.

Furthermore, a supporting part 104 that joins the attachment part 102 and the cylindrical portion 100 is formed by a part of the resin part 80 and a part of the iron part 82.

The reinforcement part 84 has its form projected to an inner diameter side of the cylindrical portion 100, and is located in the opposite side of the supporting part 104 to the direction against the center position of an axis of the belt (shown by a line P in FIG. 2).

Further, the reinforcement part 84 has a ring form that an opening opened to the inner diameter side thereof.

Furthermore, the reinforcement part 84 is a separate part from the cylindrical portion 100, but formed of the same type of material with the cylindrical portion 100 having the same coefficient of linear expansion, and is press fit and fixed to the inner surface of the cylindrical portion 100.

An interference of the press fit is set to 0.1 mm or less, and press fit is performed until a tip of the reinforcement part 84 is pressed by the nut 200.

It should be appreciated that between the cylindrical portion 100 and the reinforcement part 84 may be adhered with adhesives. In addition, at least one of touching surfaces of the cylindrical portion 100 and the reinforcement part 84 may be a cylindrical surface, or may have unevenness thereon for increasing the friction.

Thus, in the AC generator 1 of the present embodiment, since the cylindrical portion 100 of the pulley 8 serves as a supporting structure that supports one side of the belt center by the supporting part 104, and supports the other side of the belt center by the reinforcement part 84, strength of the cylindrical portion 100 can be raised and it becomes possible to raise the reliability of the pulley 8.

Moreover, the cylindrical portion 100 has the grooves that contact with the belt 300, and the portions of the grooves that contact with the belt 300 are formed with resin.

Generally, when the portion that contacts with the belt 300 is formed by resin, strength of the pulley 8 falls compared with the pulley made from steel. However, by raising strength using the reinforcement part 84, sufficient strength can be obtained even if the resin is used for the pulley 8.

Further, when casting or resin-molding the pulley 8, the reinforcement part 84 will not project to the inner diameter side by forming the reinforcement part 84 separately with the cylindrical portion 100, thus difficulties in casting or molding are avoided. Furthermore, the cylindrical portion 100 can be reliably supported from the inner diameter side by press fitting the reinforcement part 84 into the pulley 8.

In addition, by setting the interference of press fit to 0.1 mm or less, deformation of the cylindrical portion 100 can be suppressed to 0.1 mm or less, and the preciseness of the cylindrical portion 100 can be maintained.

Moreover, by making the coefficient of linear expansion of the reinforcement part 84 and the cylindrical portion 100 the same, the reinforcement part 84 escaping from the cylindrical portion 100 at the time of temperature change, or excessive stress applying to the cylindrical portion 100 from the reinforcement part 84 can be prevented.

In addition, since the opening is open to the inner diameter side of the reinforcement part 84, a weight can be lightened while raising strength of the cylindrical portion 100.

The present invention, by the way, is not limited to the above-mentioned embodiment and various modifications are possible within the limits of the summary of the present invention.

For example, as shown in FIG. 3, a reinforcement part 84A with an enlarged diameter opening that opens to the inner diameter side may be used (a first modification). The diameter of the opening in the inner diameter of the reinforcement part 84A is set larger than a nut runner (not shown) that is a jig for tightening and loosening the nut 200 used for fixing the pulley 8A. By this, attaching and removing of the pulley 8A with the reinforcement part 84A added can be attained, and assembling efficiency will be raised.

Although the opening is formed in the inner diameter side of the reinforcement parts 84 and 84A in the embodiments mentioned above, the opening may be closed from the viewpoints of such as rust prevention.

In addition, although the reinforcement parts 84 and 84A in the embodiments mentioned above are formed separately from the cylindrical portions 100 and are press fitted therein, these parts may be formed integrally.

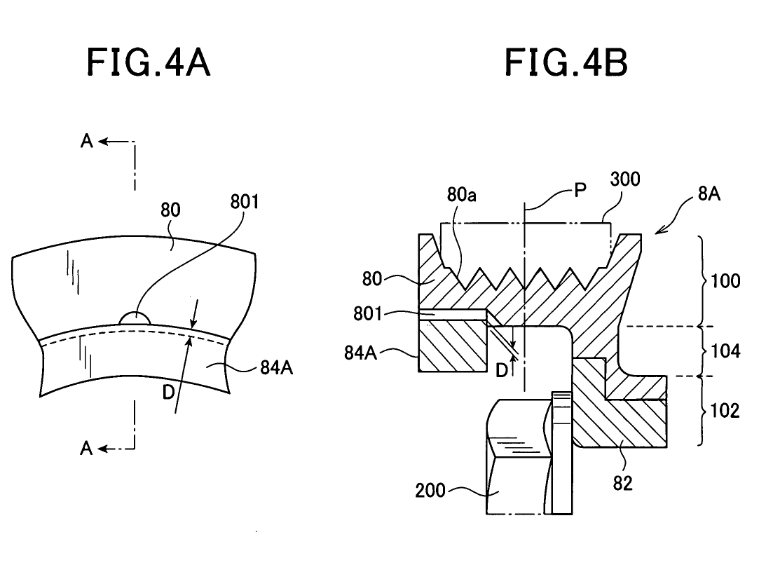

In a modification shown in FIGS. 4A and 4B (a second modification), an opening 801 as a passageway that connects from the inner surface of the cylindrical portion 100 to the outside thereof is formed in the cylindrical portion 100.

By this, corrosion of a nut 200 and the attachment part 102 can be prevented if water accumulates in the lower space surrounded by the reinforcement part 84A and the cylindrical portion 100. Processing the reinforcement part 84A and/or the attachment part 102 may form the opening 801.

Further, when forming a plurality of openings 801, pitch of 90-degree, for example, relative to each other in the position that does not produce unbalance is desirable. Furthermore, positioning in the direction of the axis at the time of assembling the reinforcement part 84A becomes easy by forming a level difference D in the inner diameter side of the cylindrical portion 100.

It should be appreciated that the above-mentioned opening 801 may be formed in the pulley 8 shown in FIG. 2. Further, the above-mentioned level difference D may be formed in the pulley 8 shown in FIG. 2 or in the pulley 8A shown in FIG. 3.

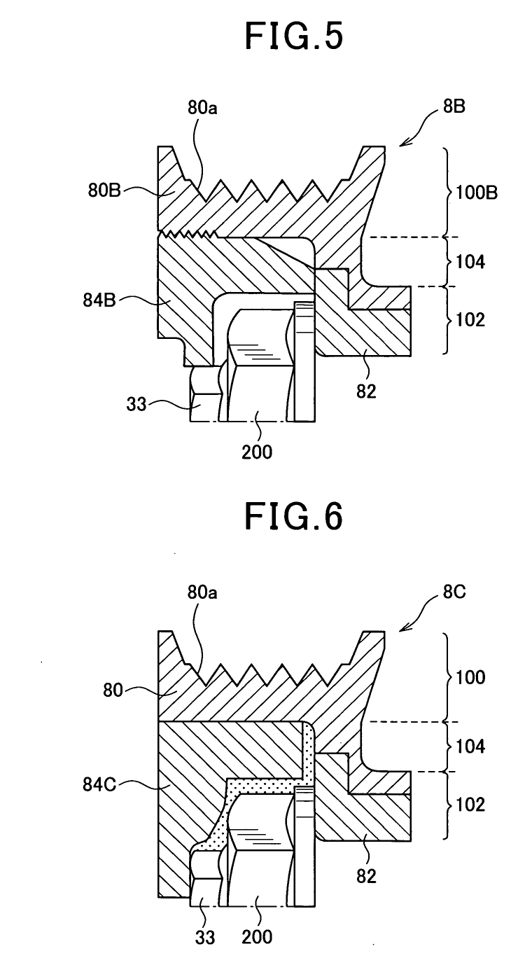

In a modification shown in FIG. 5 (a third modification), a reinforcement part 84B is screwed onto a cylindrical portion 100B.

A highly precise cylindrical part is provided in a back side (half-tip side) in the axial direction of a screw formed on the reinforcement part 84B, and the same axle is secured by positioning the outer side of the perimeter of the reinforcement part 84B to an inner surface of the cylindrical portion 100B.

The reinforcement part 84B is engaged and fixed to the attachment part 102 by pressing the reinforcement part 84B to the attaching part 102 with screw tightening force.

Further, an opening (a perfect circle) that wraps a hexagonal tip portion of the rotating shaft 33 internally is formed in the inner diameter side of the reinforcement part 84B, and by press fitting the hexagonal tip portion of the rotating shaft 33 in the opening in the inner side of the diameter of reinforcement part 84B, the reinforcement part 84B is engaged and fixed to the rotating shaft 33. Thus, secure engagement is simply possible only by tightening the screw and the rigidity as the whole rotating body can be raised.

If a hexagon socket larger than the opening of the true circle is formed in the tip side rather than the opening of the true circle in the inner diameter side of the reinforcement part 84B, tightening the screw of the reinforcement part 84B can be easily performed by using the hexagon socket.

Although the reinforcement part 84B mentioned above is engaged and fixed to the attachment part 102, it may be engaged and fixed to the supporting part 104.

Moreover, although the hexagonal tip portion of the rotating shaft 33 is press fitted into the opening of the inner diameter side of the reinforcement part 84B, the diameter of the opening may be expanded and press fit the nut 200 therein.

In a modification shown in FIG. 6 (a fourth modification), a reinforcement part 84C is fixed to other parts (the cylindrical portion 100, the attachment part 102, the supporting part 104, the nut 200, and the hexagonal tip portion of the rotating shaft 33) by using adhesives.

Thereby, the reinforcement part 84C can be adhered in all directions, but not only in the engagement of one direction by pressure connecting, such as friction.

Further, being adhered in all directions, the reinforcement part 84C and the parts of the circumference increase the integrity. With the above structure, higher rigidity structure is further expectable.

From a viewpoint of productivity, adhesives may be poured in for potting from the opening formed in the inner diameter side of the reinforcement part 84C.

For improving rigidity, the techniques shown in FIG. 5 and FIG. 6 may be combined. Further, other engaging techniques may be combined as well.

What is claimed is:

1. An electric rotary machine comprising:
a pulley fixed to a rotating shaft, and
a belt that transmits a driving force from outside to the rotating shaft via the pulley,
the pulley further comprising:
a cylindrical portion in contact with the belt,
an attachment part screwed and fixed to the rotating shaft by fitting,
a supporting part which joins the attachment part and the cylindrical portion, and
a reinforcement part that has projections on an inner diameter side of the cylindrical portion, and is located in the opposite side of the supporting part opposite side to the direction against the center position of an axis of the belt.

2. The electric rotary machine according to claim 1, wherein,
the cylindrical portion has a groove in contact with the belt, and at least a portion of the groove that touches the belt is formed with resin.

3. The electric rotary machine according to claim 1, wherein,
the reinforcement part is a separate part from the cylindrical portion, but formed of the same type of the material with the cylindrical portion having the same coefficient of linear expansion, and is press fit and fixed to an inner surface of the cylindrical portion.

4. The electric rotary machine according to claim 3, wherein,
when the reinforcement part is press fit into the cylindrical portion, an interference of the press fit is set to 0.1 mm or less.

5. The electric rotary machine according to claim 1, wherein,
the reinforcement part has an opening opened to the inner diameter side thereof.

6. The electric rotary machine according to claim 5, wherein,
a diameter of the opening in the inner diameter of the reinforcement part is set larger than a jig for tightening and loosening a nut for screwing the attachment part to the rotating shaft.

7. The electric rotary machine according to claim 1, wherein,
a passageway that connects from the inner surface of the cylindrical portion to the outside thereof is formed in the cylindrical portion.

8. The electric rotary machine according to claim 1, wherein,
while the reinforcement part is a separate part from the cylindrical portion, but formed of the same type of the material with the cylindrical portion having the same coefficient of linear expansion, and is engaged to the cylindrical portion,
the reinforcement part is engaged and fixed to either the attachment part or to the supporting part.

9. The electric rotary machine according to claim 8, wherein,
while the reinforcement part engages with the cylindrical portion according to a screw structure,
the reinforcement part is engaged and fixed by press fitting to either the attachment part or to the supporting part in the direction of its axis.

10. The electric rotary machine according to claim 8, wherein,
the reinforcement part is engaged and fixed to the cylindrical portion, the attachment part, and the supporting part by adhesion.

11. The electric rotary machine according to claim 1, wherein,
while the reinforcement part is a separate part from the cylindrical portion and engaged to the cylindrical portion,
the reinforcement part is engaged and fixed to either the nut used for the screwing or to the rotating shaft.

12. The electric rotary machine according to claim 11, wherein,
while the reinforcement part engages with the cylindrical portion according to the screw structure,
the reinforcement part is engaged and fixed by press fitting to either the nut or to the rotating shaft in the direction of its axis.

13. The electric rotary machine according to claim 11, wherein,
the reinforcement part is engaged and fixed to the cylindrical portion, the nut, and the s rotating shaft by adhesion.
